(19) United States
(12) Patent Application Publication
(10) Pub. No.: US 2008/0301300 A1
(43) Pub. Date: Dec. 4, 2008

(54) Predictive asynchronous web pre-fetch

(75) Inventor: Stephen H. Toub, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/809,496

(22) Filed: Jun. 1, 2007

(51) Int. Cl. G06F 15/16

(52) U.S. Cl. 709/227

(57) ABSTRACT

A web server receives an asynchronous pre-request of data from a web browser resulting from the web browser predicting a user action based on the user's interaction with the web browser. The web server pre-fetches the pre-requested data based on the asynchronous pre-request of data.

### BACKGROUND

The Internet comprises numerous computers and network devices that employ various protocols to communicate with one another. A client computer coupled to the Internet typically downloads digital data or information from a server computer coupled to the Internet. Client application software executing on the client computer typically accepts commands from a user and obtains data and services by sending requests to server applications running on server computers connected to the Internet. Numerous protocols can be employed to exchange commands and data between computers connected to the Internet, such as the file transfer protocol (FTP), the hypertext transfer protocol (HTTP), the simple mail transport protocol (SMTP), and the Gopher document protocol.

The HTTP protocol is typically employed to access data on the World Wide Web. The World Wide Web is an information service on the Internet providing documents and links between documents. The World Wide Web comprises numerous web sites located around the world that maintain and distribute electronic documents. A web site may use one or more web server computers that store and distribute documents in one of a number of formats including the hypertext markup language (HTML). An HTML document includes text and metadata such as commands providing formatting information. HTML documents also include embedded links that reference other data or documents located on any web server computer. The referenced documents may represent text, graphics, video, etc.

A web browser is a client application or operating system utility that communicates with server computers via FTP, HTTP, Gopher protocols, and/or other suitable protocols. Web browsers receive electronic documents from a network and present them to a user.

Some web sites cache frequently used data in order to speed up the return of requested data to a user of a web browser. The first request to retrieve or compute data from a first user typically has a slow response, but after the web server caches the retrieved or computed data, subsequent requests from the first user or other users for that same data can be returned from the cache to provide a faster web browser experience to the users making the subsequent requests. In situations where data is specific to the user, data can be cached just for that user, but the above example type of caching mechanism typically will not provide a significantly faster experience to the other users. In situations where all or a relatively large portion of data cannot be cached for some reason, the above example type of caching mechanism typically cannot be used or will not provide a significantly faster experience to the users.

In another example type of caching mechanism, a web server predicts what data might be requested by a user. The predicted data is obtained and then cached ahead of time, based on previous user requests. For example, an example web site that employs image tiles for geography or maps, could pre-cache image tiles for geography or maps surrounding the user's current location based on the premise that there is a high likelihood that regions surrounding the user's current location will be selected for viewing by the user. This type of caching mechanism supports domain-specific web site navigation, such as map viewing, but typically does not apply to general web site navigation.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

One embodiment of a web server controls a server computer. The web server receives an asynchronous pre-request of data from a web browser resulting from the web browser predicting a user action based on the user's interaction with the web browser. The web server pre-fetches the pre-requested data based on the asynchronous pre-request of data.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram of one embodiment of a networked Internet environment including a client computer and a server computer.

FIG. 2 is a block diagram of an exemplary computer environment embodiment in which various implementations on a client computer or a server computer can be practiced.

FIG. 3 is a flow diagram illustrating one embodiment of a method performed by a web browser including asynchronously pre-requesting web data based on a user's interaction with the browser.

FIG. 4 is a flow diagram illustrating one embodiment of a method performed by a web server including pre-fetching database data based on an asynchronous pre-request of data from a web browser.

FIG. 5 is a diagram illustrating one embodiment of a method performed by a web server including providing a script to a web browser and registering a method with the browser.

FIG. 6 is a flow diagram illustrating one embodiment of a method performed by a web server including pre-fetching database data based on an asynchronous pre-request of data from a web browser and employing ASP.NET to return asynchronous result pre-markers.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

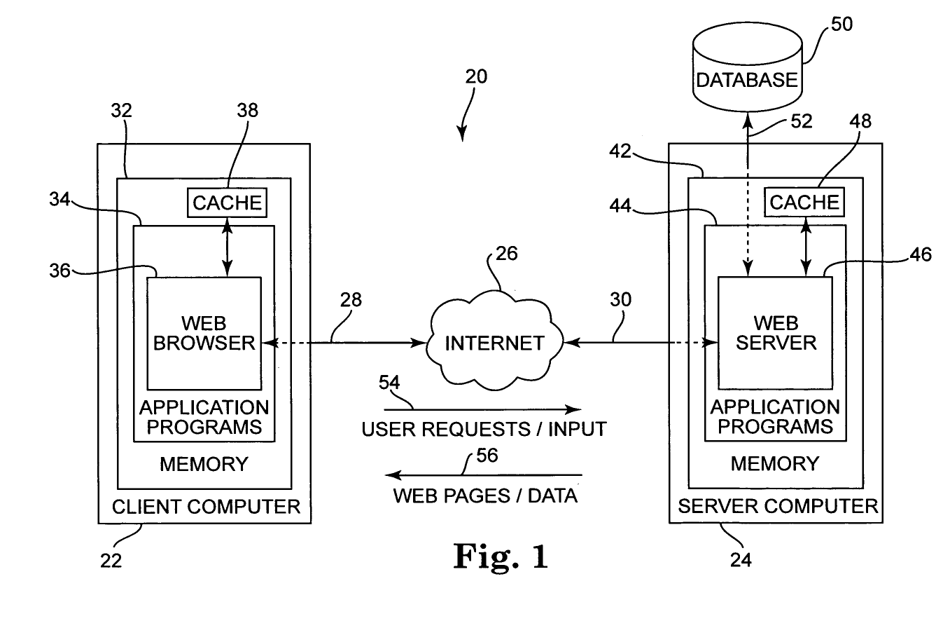

One embodiment of a networked Internet environment 20 is illustrated in block diagram form in FIG. 1. Networked Internet environment 20 includes a client computer 22 and a server computer 24. Client computer 22 is coupled to server computer 24 via the Internet indicated at 26. Client computer 22 is coupled to Internet 26 via bi-directional communication paths 28. Server computer 24 is coupled to Internet 26 via bi-directional communication paths 30.

Client computer 22 includes memory 32 which stores application programs 34 which are locally executed on client computer 22. Application programs 34 include a web browser 36. Client computer 22 includes a cache 38 for storing recently requested web pages and web data.

Server computer 24 includes memory 42 which stores application programs 44 which are locally executed on server computer 24. Application programs 44 include a web server 46. Server computer 24 includes a cache 48 for storing recently accessed or pre-fetched web pages and/or data.

A database 50 stores web pages and other web data in database files. Database 50 bi-directionally communicates with web server 46 via communication paths 52. In one embodiment, database 50 is implemented in a remote computer or other remote device. In one embodiment, database 50 is implemented in server computer 24. In either embodiment, web server 46 can access data stored in cache 48 faster that it can access data stored in database 50.

Generally, web browser 36 makes user requests and/or provides user input as indicated at 54 via Internet 26 to web server 46. Web server 46 receives the user request/input indicated at 54 and fetches the requested web page/data from database 50 via communication path 52 if the requested web page/data is not already stored in cache 48. Web server 46 stores the fetched data from database 50 in cache 48 and returns the fetched web page/data as indicated at 56 to web browser 36 via Internet 26.

In one embodiment, once a network connection is established between client computer 22 and server computer 24, a user of client computer 22 can access a desired web page by supplying web browser 36 with a corresponding web address (e.g., a uniform resource locator (URL) for that page. A page, in this context, refers to content accessed via a URL, including text, graphics and other such information. The URL address can be supplied through any of various techniques, such as for example direct keyboard entry by a user, selection among a stored list of addresses (i.e., bookmarks), or clicking on a user interactable component (e.g., link) via a pointing device, such as a mouse, for that URL address, then appearing on a browser control bar or a home page or other web page currently being displayed by web browser 36.

Once a user has supplied input to web browser 36, the browser sends appropriate user requests/input as indicated at 54 to web server 46. This user request/input can be the URL address for a web page itself or a request to retrieve a stored file for a web page for which the user has then supplied an address. Upon receipt of the web pages/data file from web server 46, web browser 36 processes the web pages/data file and assembles and renders a web page represented by the file or updates the already rendered web page with new data from the file. The rendered web page is typically displayed on a local display of client computer 22 from which the user can examine the rendered page. Once the displayed page is fully rendered or fully updated or the user has instructed web browser 36 to stop rendering the page via an explicit stop command or via a click on a link already rendered, the user can then enter a new web address via a link or update data in the rendered page via a click of another link. For example, in one embodiment by simple successive pointing and clicking of the user pointing device on appropriate links corresponding to desired web pages or updates to web pages, a user can easily retrieve desired web pages or update data in web pages in succession from one or more corresponding web sites during a typical web session.

There is, however, a desire to provide a faster experience to users of a given web site for updating web pages and data in a rendered web page. One embodiment of web browser 36 predicts a user action based on a user's interaction with browser 36. For example, in one embodiment as described in more detail below web browser 36 predicts that the user is about to select a user interactable component (e.g., click on a link) based on tracking linear movement of a pointing device (e.g., a mouse) towards the user interactable component. This embodiment of web browser 36 makes an asynchronous pre-request of data to web server 46. After making the actual request of data to web server 46, web browser 36 receives the requested data from the web server that was pre-fetched from database 50 and cached on server computer 24 in cache 48 based on the asynchronous pre-request. If the asynchronous pre-request was based on an incorrect prediction or if no asynchronous pre-request was made, web browser 36 receives the requested data from web server 46 that was directly fetched from database 50 or retrieved from cache 48 based on the actual request.

One embodiment of web server 46 receives the asynchronous pre-request of data from web browser 36. This embodiment of web server 46 pre-fetches the pre-requested data from database 50. Web server 46 stores the pre-fetched data in cache 48. When the actual request of data from web browser 36 is received, web server 46 determines if there was a pre-request of data from the browser. In this embodiment, if there was no pre-request, web server 46 fetches the data from database 50, stores the fetched data in cache 48, and returns the fetched data to web browser 36. If there was a pre-request, web server 46 determines if the pre-request of data is complete. In this embodiment, if the pre-request of data is complete, web server 46 processes the actual request and returns the pre-fetched data from cache 48 to web browser 36. In one embodiment, if the pre-request of data is not complete, web server 46 blocks the actual request until the asynchronous pre-request completes, then finishes processing the actual request to return the pre-fetched data from cache 48 to web browser 36.

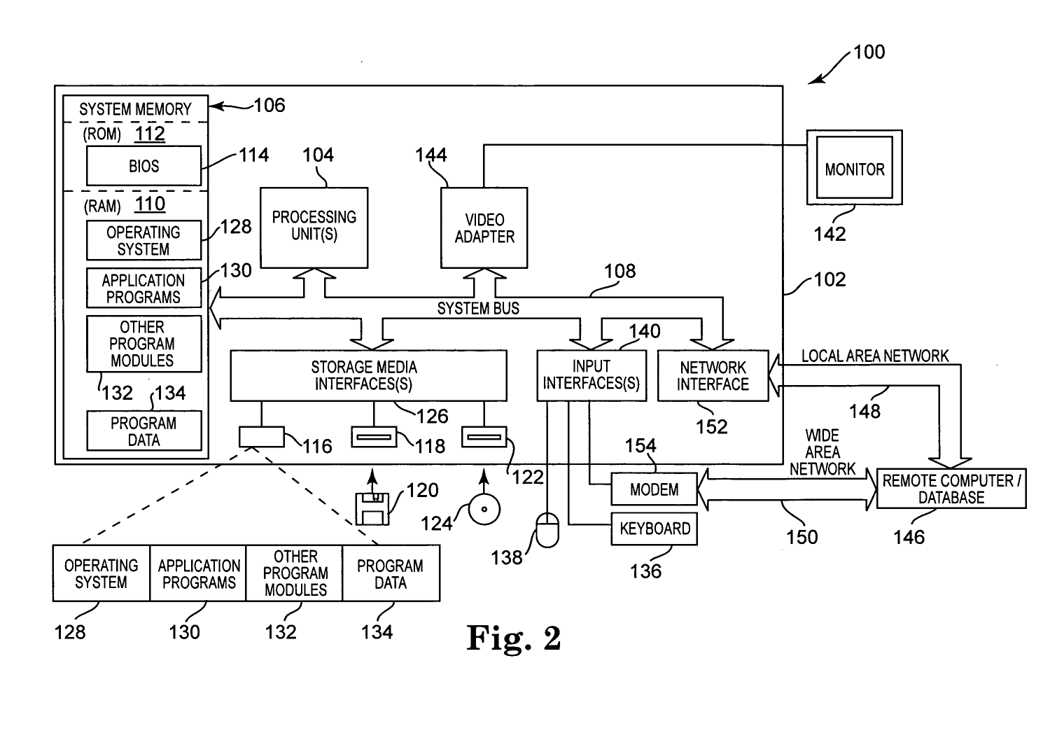

One embodiment of an exemplary computer hardware and operating environment 100 in which various implementations on a client computer or a server computer can be practiced is illustrated in block diagram form in FIG. 2. Computer environment 100 is only one example of a suitable computer environment and is not intended to suggest any limitation as to the scope of use or functionality of the embodiments. The embodiments described above and below can be implemented in any corresponding suitable client computer environment or corresponding suitable server computer environment. Accordingly, computer environment 100 is not intended to be interpreted as having any dependency or requirement related to any one or combination of the components illustrated in the exemplary computer environment 100 embodiment.

Client computer 22 or server computer 24 can each be implemented with a suitable computer environment, such as computer environment 100. In one embodiment, however, server computer 24 includes a larger hard drive and more memory capacity (e.g., more random access memory (RAM)) compared to client computer 22.

Techniques of the above and below described embodiments can be operational with numerous other general purpose or special purpose computing system environments or configurations. Examples of suitable computer systems, environments, and/or configurations suitable to be employed with the described embodiments include but are not limited to: personal computers; server computers; thin clients; thick clients; hand-held devices; laptop devices; multiprocessor systems; microprocessor based systems; set top boxes; programmable consumer electronics; network personal computers; mini computers; mainframe computers; and distributed computing environments that include any of the above systems or devices.

Certain embodiments are described herein in the general context of computer-executable instructions, such as program modules, being executed by a computer. Generally, program modules include routines, programs, objects, components, data structures, etc. that perform particular tasks or implement particular abstract data types. Embodiments may also be practiced in distributed computing environments where tasks are performed by remote processing devices that are linked through a communications network. In a distributed computer environment, program modules may be located in both local and remote computer storage media including memory storage devices.

Computer environment 100 includes a general purpose computer 102 including one or more processors or processing units 104, a system memory 106, and a system bus 108 that operatively couples various system components including system memory 106 to processor 104.

System bus 108 can be implemented in any of several types of suitable bus structures including a memory bus or a memory controller, a peripheral bus, an accelerated graphics port, and a processor or local bus using any of a variety of suitable local bus architectures.

Computer environment 100 can include a variety of computer readable storage media. Such computer readable storage media may be any suitable available storage media that is locally and/or remotely accessible by computer environment 100, and includes both volatile and non-volatile storage media, removable and non-removable storage media.

System memory 106 (also referred to as memory 106) includes computer readable storage media comprising volatile memory, such as RAM 110, and/or non-volatile memory, such as read-only memory (ROM) 112. ROM 112 stores a basic input/output system (BIOS) 114 containing basic routines that facilitate transfer of information between elements within computer 102, such as during start-up. RAM 110 typically stores data and/or program modules that are immediately accessible to and/or presently being operated on by processing unit(s) 104.

Embodiments of computer environment 100 include other removable/non-removable, volatile/non-volatile computer storage media. In the illustrated embodiment, computer environment 100 includes a hard disk drive 116 configured to read from and write to a non-removable, non-volatile magnetic media (i.e., a hard disk), a magnetic disk drive 118 configured to read from and write to a removable, non-volatile magnetic disk 120 (e.g., a floppy disk), and an optical disk drive 122 configured to read from and/or write to a removable non-volatile optical disk 124 (e.g., a CD-ROM, DVD-ROM or other optical media). Hard disk drive 116, magnetic disk drive 118, and optical disk drive 122 are each coupled to system bus 108 by one or more suitable storage media interfaces 126.

The above described drives and their associated computer-readable media provide non-volatile storage of computer readable instructions, data structures, program modules, and other data for computer 102. Although the exemplary illustrated computer environment 100 employs a hard disk in hard disk drive 116, a removable magnetic disk 120, and removable optical disk 124, other suitable types of computer readable storage media which can store data that is accessible by a computer, such as universal serial bus (USB) flash drives, magnetic cassettes, flash memory cards, digital video disks, RAMs, ROMs, and the like, may also be used in embodiments of computer environment 100.

A number of program modules may be stored on the hard disk in hard disk drive 116, magnetic disk 120, optical disk 124, ROM 112, and/or RAM 110 or other suitable types of computer readable storage media (e.g., USB flash drive). For example, in the illustrated embodiment of computer environment 100, the hard disk in hard disk drive 116 and RAM 110 store, for example, an operating system 128, one or more application programs 130 (e.g., web browser 36 in client computer 22 or web server 46 in server computer 24), other program modules 132, and program data 134. In one embodiment, some of application programs 130 are configured to present a user interface (UI) that is configured to allow a user to interact with the application program in some manner using some type of input device. In one embodiment, this UI is a visual display that is capable of receiving user input and processing that user input in some way. Embodiments of such a UI can, for example, include one or more user interactable components (e.g., links, buttons or controls) that can be selected (e.g., clicked) by a user via a pointing device.

A user may enter commands and information into computer 102 via input devices, such as keyboard 136 and pointing device 138 (e.g., a mouse). Other input devices may include an audio/video input device, a microphone, a joy stick, a game pad, satellite dish, scanner, or any other suitable input device. These suitable input devices are coupled to processing unit(s) 104 via input interface(s) 140 that is coupled to system bus 108, but may be coupled by other interface and bus structures. Suitable input interfaces 140 include a serial port interface, a parallel port, game port, and/or a universal serial bus (USB).

In the illustrated embodiment, a monitor 142 or other type of display device is coupled to system bus 108 via an interface, such as a video adapter 144.

In one embodiment, computer 102 operates in a networked environment using logical connections to one or more remote computers, such as remote computer and/or database 146. As a remote computer, remote computer 146 can include many or all of the elements and features described above relative to computer 102. As a database, remote database 146 can be implemented as a server database, such as server database 50 illustrated in FIG. 1. Remote computer/database 146 may be, for example, another computer, a database, a server, a client, a router, a network personal computer, a peer device or other common network node.

In the illustrated embodiment, computer 102 can be coupled to remote devices, such as remote computer/database 146, through a local area network (LAN) 148 and/or a general wide area network (WAN) 150. Such networking environments are employed in, for example, offices, enterprise-wide computer networks, intranets, and the Internet.

In a LAN networking environment embodiment, computer 102 is coupled to LAN 148 through a suitable network interface or adapter 152. In a WAN networking environment embodiment, computer 102 can include a modem 154 or other suitable mechanism for establishing communications over the WAN 150. Modem 154 can be internal or external and can be connected to system bus 108 via user input interface 140 or other appropriate mechanism.

In a networked environment, program modules depicted relative to computer 102, or portions thereof, may be stored in a remote memory storage device. In addition, the network connections illustrated in FIG. 2 are exemplary and other suitable mechanisms of establishing communication between the computers may be used.

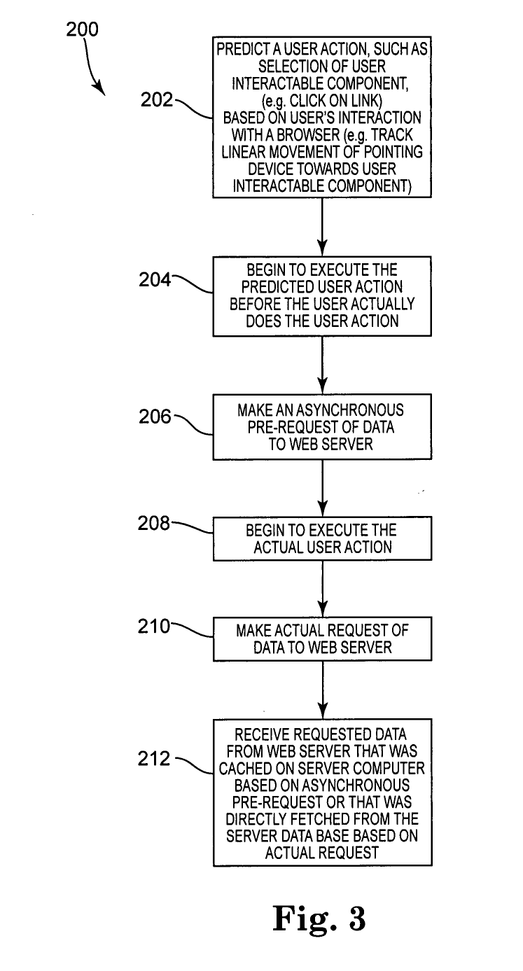

One embodiment of a method 200 performed by a web browser, such as web browser 36 of client computer 22, is illustrated in flow diagram form in FIG. 3. At 202 the web browser predicts a user action based on the user's interaction with the browser. For example, in one embodiment, the web browser predicts that a user is about to select a user interactable component (e.g., click on a link) based on tracking linear movement of a pointing device (e.g., mouse) towards a user interactable component by the user. Examples of suitable user interactable components include, but are not limited to a link, a submit button, user selectable image, a suitable interactive component of a web page that interacts with a pointing device via movement of the pointing device over the component. In one embodiment, the web browser predicts that the user is about to select a user interactable component (e.g., click on a link) based on input from a keyboard, such as by recognizing that the user is pressing a down button and then pauses at a particular link where the web browser anticipates that, for example, the user will click the particular link with the space bar. Any suitable user interaction with the browser that hints at what user interactable components are going to be selected next and that can be suitably analyzed by the browser or other application program can be used. For example, in one embodiment, a speech recognition system permits the user to speak to the link which it wants to browse to and based on the user's speech, the browser predicts what link the user wants to browse to next.

In one embodiment where the web browser predicts that a user is about to select a user interactable component (e.g., click on a link) based on tracking linear movement of a pointing device, the web browser is implemented in a suitable web browser that allows tracking movement of the pointing device. For example, coordinates of where a pointing device is currently positioned in a UI display can be tracked over time using a tracking mechanism similar to what web sites employ to track where users are in a UI display and how users are using the web site. In one embodiment, a script is loaded from a web server, such as web server 46, that tracks pointing device movement in real time and analyzes pointing device movement to linearly project movement of the pointing device towards a user interactable component (e.g., link) to thereby extrapolate that one of the user interactable components in the linear projection path is the user interactable component that the user is actually targeting to select (e.g., click on) next. Other embodiments may extrapolate curves or other geometric formations from a tracked path of a pointing device towards a user interactable component.

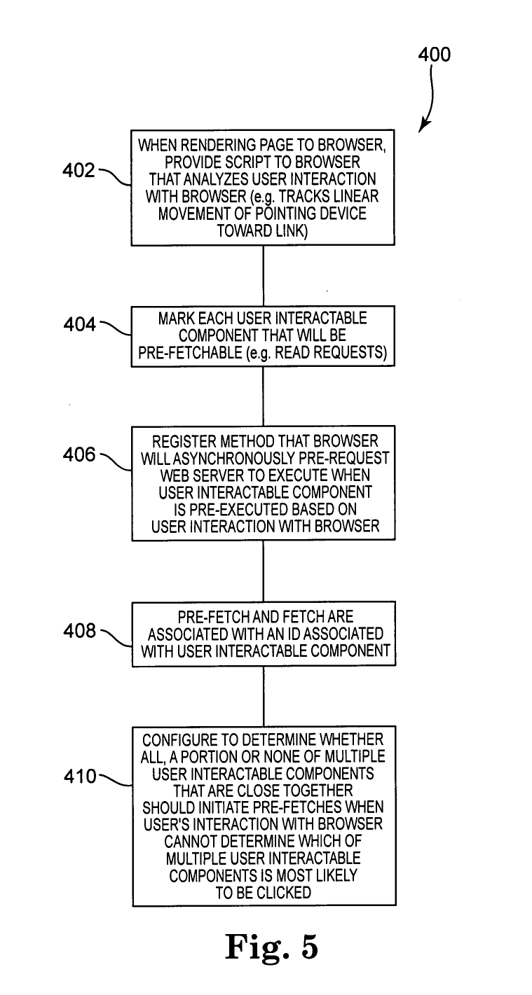

At 204, the web browser begins to execute the predicted user action before the user actually does the user action. For example, in one embodiment, the web browser begins to pre-execute a predicted selection of a user interactable component (e.g., click on a link). In one embodiment as described further below in the text corresponding to FIG. 5, the predicted selection of a user interactable component is not pre-executed unless the user interactable component is marked as supporting an asynchronous pre-fetch model (i.e., the user interactable component is marked as being pre-fetchable). For example, in one embodiment, purely read request user interactable components are marked as being pre-fetchable by the web server and user interactable components that initiate actions causing changes to data or writing actions would not be marked as being pre-fetchable. At 206, the web browser makes an asynchronous pre-request of data to the web server when executing the predicted user action. As described above and in more detail below, this asynchronous pre-request of data to the web server will initiate the web server to pre-fetch data from a database, such as database 50, and store the pre-fetched data in a cache, such as cache 48 in server computer 24.

At 208, the web browser begins to execute the actual user action based on the user actually doing the user action, such as an actual click on a link with a pointing device. At 210, the web browser makes the actual request of data to the web server. At 212, the web browser receives requested data from the web server that was cached in a cache on the server computer based on the asynchronous pre-request if the asynchronous pre-request was made at 206. If the asynchronous pre-request of data was not made at 206, the web browser receives the requested data from the web server that was directly fetched from the server database based on the actual request.

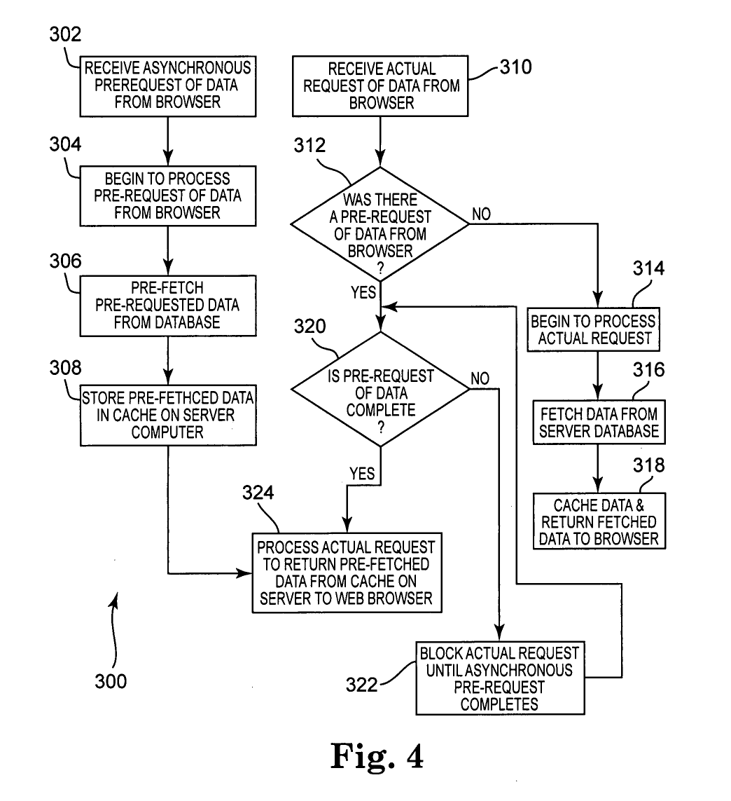

One embodiment of a method 300 performed by a web server, such as web server 46 of server computer 24, is illustrated in flow diagram form in FIG. 4. At 302, the web server receives an asynchronous pre-request of data from a web browser, such as web browser 36 of client computer 22. At 304, the web server begins to process the pre-request of data from the web browser. At 306, while processing the pre-request of data, the web server pre-fetches the pre-requested data from a database, such as database 50. At 308, the web server stores the pre-fetched data in a cache, such as cache 48 on server computer 24.

At 310, the web server receives an actual request of data from the web browser. At 312, the web server determines whether there was a pre-request of data from the web browser.

If at 312, there was not a pre-request of data from the web browser, at 314, the web server begins to process the actual request of data. At 316, the web server fetches data from the server database. At 318, the web server stores the fetched data in the cache on the server computer and returns the fetched data to the web browser.

If at 312, there was a pre-request of data from the web browser, at 320, the web server determines if the pre-request of data is complete. If the pre-request of data is not complete, at 322, the web server blocks the actual request of data until the asynchronous pre-request completes. If the pre-request of data is complete, at 324, the web server processes the actual request to return the pre-fetched data from the cache on the server computer to the web browser.

FIG. 5 is a diagram illustrating one embodiment of a method 400 performed by a web server, such as web server 46 of server computer 24. The acts and steps illustrated in FIG. 5 for method 400 are not necessarily performed in the order presented below and can be performed dependently or independently.

In one embodiment, such as indicated at 402, when the web server is rendering a page to a web browser, such as web browser 36 of client computer 22, the web server provides a script to the web browser that analyzes user interaction with the browser. For example, in one embodiment the script analyzes and tracks linear movement of a pointing device (e.g., a mouse) towards a user interactable component (e.g., link). Some embodiments of suitable scripts are discussed above in reference to FIG. 3. In one embodiment, one or more of the herein described script functions are built into the web browser.

In one embodiment, such as indicated at 404, the web server marks each user interactable component (e.g., link) that will be pre-fetchable. For example, in one embodiment user interactable components that initiate purely read requests are marked as being pre-fetchable while user interactable components that would initiate an action to make changes or user interactable components that would initiate a writing action would not be marked as pre-fetchable.

In one embodiment, such as indicated at 406, the web server registers a method that the web browser will asynchronously pre-request the web server to execute when a user interactable component (e.g., link) is pre-executed based on a user interaction with the browser. The method can be called by the browser to have the web server pre-fetch data from a database, such as database 50, but instead of returning the results of the pre-fetch action, the web server would only cache the results in a cache, such as cache 48. In one embodiment, this method is built into the web server. In one embodiment, the method is generic code that is re-used. In one embodiment, the method is customizable by a developer of the website, such that instead of only caching the data results, other functions could be performed by the method, such as logging information or modifying the data results in some manner, or other suitable desired function.

In one embodiment, a user could specify a user function to be added to the method.

In one embodiment, such as indicated at 408, the pre-fetch and the fetch are associated with an identification (ID) associated with the user interactable component. In one embodiment, this ID allows the web browser script to track what pre-requests the web browser has already made and not reissue pre-request's that the web browser has previously made. In one embodiment, this ID is employed as part of a cache key on the server computer that ties the cached data back to the specific user interactable component/pre-request/request that was made.

In one embodiment, such as indicated at 410, the web server configures to determine whether all, a portion, or none of multiple user interactable component (e.g., links) that are close together in a UI display should initiate pre-fetches when a user's interaction with a browser can not determine which of the multiple user interactable components is most likely to be selected (e.g., clicked on). For example, a user pointing device movement may indicate that there are three user interactable components that are in the linear projection of the pointing device movement that are marked as being pre-fetchable. In one configuration, all the user interactable components will initiate pre-fetches and stores of the pre-fetched data in the server computer cache and if one or more of the user interactable components is actually clicked on, the pre-fetched results can be obtained from the cache. In one configuration, a selected number of the multiple user interactable components are selected to initiate pre-fetches. For example, in one embodiment, there may be a pre-fetchable link limit (N), such that only up to N of the most likely link candidates are pre-fetched. In one configuration, none of the multiple user interactable components that are equally likely to be clicked on are selected to initiate pre-fetches. Typically, web servers have additional processing power that can be taken advantage of by pre-executing extra pre-fetch actions ahead of time. This increase in processing power provides a user with a faster experience on the website as long as one of the pre-executed user interactable components is actually selected (e.g., clicked on). This configuration is essentially determined by evaluating if the overhead associated with pre-executing the extra user interactable components that will not actually be selected is worth the faster experience by the user on the website.

Other aspects of the pre-requesting and pre-fetching methods performed by the web server can also be configured. In some embodiments, this configuration is dynamic over time. For example, in one embodiment, the web server could analyze the user's behavior over time such that if a user doesn't or rarely clicks on a particular link that the pointing device movement linearly projects the user to click on, the web server could turn off certain selective links or turn off the entire system based on the analysis of the user behavior. Analysis of user behavior could also be employed to expand the number of user interactable component (e.g., links) that are pre-executed to initiate a pre-fetch. For example, in one embodiment, based on a linear projection of pointing device movement that a user is about to click on a certain link, the user's analyzed behavior might suggest that other nearby or associated links are highly likely to be clicked on after the linearly projected link is clicked on, so these links could also be pre-executed to initiate a pre-fetch. One exemplary configuration could be based on how close to a projected linear path a link needs to be in order for the link to be pre-executed to initiate a pre-fetch.

In one embodiment, if a pre-request of data is made from the web browser to the web server as a result of the web browser predicting a user action based on the user's interaction with the browser, the asynchronous pre-request of data initiates a pre-fetch action in the web server which is fully processed to pre-fetch the pre-requested data from the database and store the pre-fetched data in the cache on the server computer regardless of if the prediction of the user action was correct. In one embodiment, if the prediction of a user action based on the user's interaction with the browser is determined to be incorrect, such as if the web browser determines that a link is about to be clicked on based on linear movement of a pointing device towards the link, but the link is not actually clicked on after a given time period, the pre-fetch of the pre-requested data for the link is cancelled. Note, however, canceling an action is typically not a very reliable operation and it can be difficult to cancel operations that are in progress. In addition, the extra cache data resulting from incorrect predictions, in certain embodiments is simply expunged from the cache when other data is stored in the cache from either actual requests or pre-requests of data.

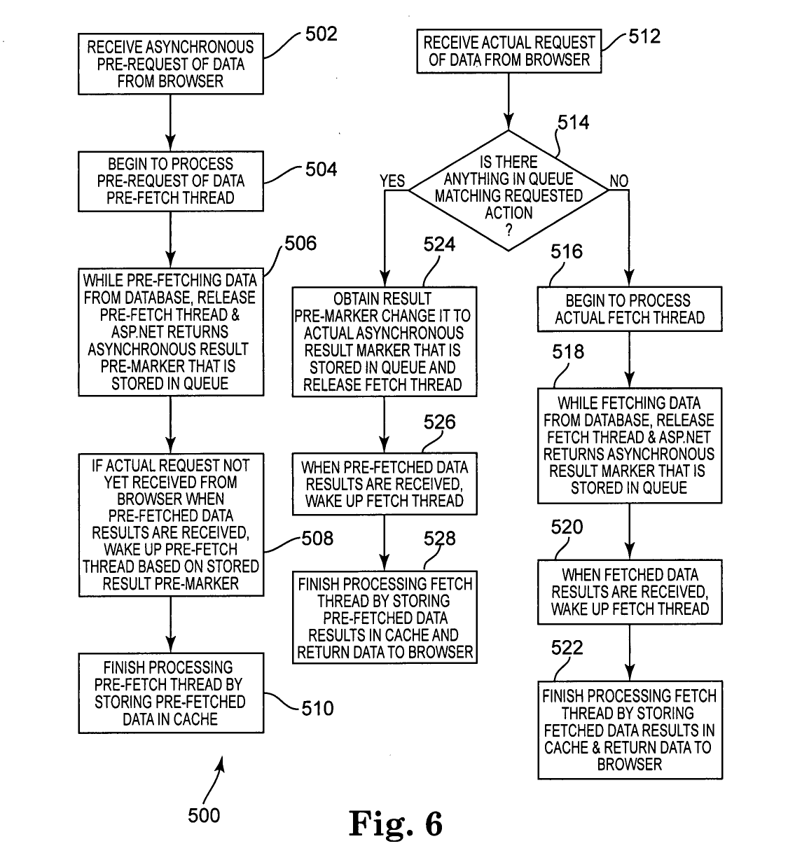

One embodiment of a method 500 performed by a web server, such as web server 46 of server computer 24, is illustrated in flow diagram form in FIG. 6. At 502, the web server receives an asynchronous pre-request of data from a web browser, such as web browser 36 of client computer 22. At 504, the web server begins to process the pre-request of data as a pre-fetch thread. The pre-fetch thread blocks waiting for the pre-fetch data result.

At 506, while pre-fetching data from a database, such as database 50, the web server releases the blocked pre-fetch thread and a suitable high level web application development platform, such as ASP.NET, returns an asynchronous result pre-marker that is stored in a queue. By employing a suitable high level web application development platform, such as ASP.NET, the asynchronous result pre-marker allows the executing process to be disassociated from the hardware resources in the server computer, such as server computer 24, which are needed to execute the process. The asynchronous result pre-marker contains information corresponding to in process execution (e.g., pre-fetching data) on the server computer.

At 508, if the actual request has not yet been received from the web browser when the pre-fetched data results are received, the web server wakes up a pre-fetch thread based on the asynchronous result pre-marker stored in the queue. This woken up pre-fetch thread can be the same pre-fetch thread that initiated the pre-fetch or it can be a different pre-fetch thread that is based on the asynchronous result pre-marker stored in the queue. At 510, the web server finishes processing the woken up pre-fetch thread by storing the pre-fetched data in a cache, such as cache 48 of server computer 24.

At 512, the web server receives an actual request of data from the web browser. At 514, the web server determines if there is anything in the queue matching the requested action.

At 516, if there was nothing in the queue matching the requested action, the web server begins to process an actual fetch thread. The fetch thread blocks waiting for the fetch data result. At 518, while fetching data from the database, the web server releases the blocked fetch thread and a suitable high level web application development platform, such as ASP.NET, returns an asynchronous result marker that is stored in the queue. At 520, when the web server receives the fetched data results, the web server wakes up a fetch thread based on the asynchronous result marker stored in the queue. This woken up fetch thread can be the same fetch thread that initiated the fetch or it can be a different fetch thread that is based on the asynchronous result marker stored in the queue. At 522, the web server finishes processing the woken up fetch thread by storing the fetched data results in the cache and returning the fetched data results to the web browser.

At 524, if there was an asynchronous result pre-marker in the queue matching the requested action, the web server obtains the result pre-marker from the queue. Also at 524, the web server changes the asynchronous result pre-marker to an actual asynchronous result marker that is stored in the queue and releases the blocked fetch thread. At 526, when the web server receives the pre-fetched data results, the web server wakes up a fetch thread based on the actual asynchronous result marker stored in the queue. At 528, the web server finishes processing the fetch thread by storing the pre-fetched data results in the cache and returning the pre-fetched data results to the web browser.

Method 500 can be employed to minimize the number of threads used in the server computer to thereby take up less system resources in the server computer for both the pre-request and the actual request of data. This provides an advantage because a thread is a highly valuable system resource in the server computer. A thread takes up processor resources and memory resources and needs to be managed with other threads the processor is scheduling. Therefore, it is desirable to minimize the number of threads used for a given process or action. By employing a suitable high level web application development platform, such as ASP.NET, the asynchronous result pre-marker and the actual asynchronous result marker allow a pre-fetch thread to be released and a fetch thread to be released. In addition, method 500, at 524, obtains the asynchronous result pre-marker and changes it to the actual asynchronous result marker.

In one example embodiment of a web server that does not employ a method such as method 500, the pre-request initiates a pre-fetch thread and the actual request initiates a fetch thread and both the pre-fetch thread and the fetch thread are blocking waiting for the same data result. In this embodiment, when the action is completed (i.e., the data results are received that both the pre-fetch thread and the fetch thread are waiting on), the pre-fetch thread is terminated and the fetch thread is woken up to process, cache, and return the data to the user.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A computer readable storage medium storing computer-executable instructions for controlling a server computer to perform a method comprising:
receiving an asynchronous pre-request of data from a web browser resulting from the web browser predicting a user action based on the user's interaction with the web browser; and
pre-fetching the pre-requested data based on the asynchronous pre-request of data.

2. The computer readable storage medium of claim 1, wherein the method comprises:
storing the pre-fetched data in a cache.

3. The computer readable storage medium of claim 2, wherein the method comprises:
receiving an actual request of data from the web browser based on the user actually performing the predicted user action; and
processing the actual request of data including returning the pre-fetched data from the cache to the web browser.

4. The computer readable storage medium of claim 1, wherein the pre-fetching comprises:
pre-fetching the data from a database in communication with the server computer.

5. The computer readable storage medium of claim 1, wherein the method comprises:
receiving an actual request of data from the web browser based on the user actually performing the predicted user action; and
processing the actual request of data including returning the pre-fetched data to the web browser.

6. The computer readable storage medium of claim 5, wherein the method comprises:
blocking the actual request of data until pre-fetching the pre-requested data based on the asynchronous pre-request of data is complete.

7. The computer readable storage medium of claim 1, wherein the predicted user action is a selection of a user interactable component.

8. The computer readable storage medium of claim 7, wherein the user's interaction with the web browser is movement of a pointing device toward the user interactable component.

9. The computer readable storage medium of claim 7, wherein the method comprises:
marking each user interactable component that will be pre-fetchable.

10. The computer readable storage medium of claim 1, wherein the method comprises:
releasing a pre-fetch thread in the server computer while pre-fetching the pre-requested data;
storing an asynchronous result pre-marker; and
if an actual request of data has not been received from the web browser when the pre-fetching of the pre-requested data is complete, waking a pre-fetch thread based on the stored asynchronous result pre-marker and finish processing the woken up pre-fetch thread by storing the pre-fetched data in a cache.

11. The computer readable storage medium of claim 10, wherein the method includes:
receiving an actual request of data from the web browser;
matching the actual request to the stored asynchronous result pre-marker;
changing the stored asynchronous result pre-marker to an actual asynchronous result marker;
releasing a fetch thread in the server computer; and
when the pre-fetching of the pre-requested data is complete, waking a fetch thread based on the stored actual asynchronous result marker and finishing processing the woken up fetch thread by storing the pre-fetched data in the cache and returning the pre-fetched data to the web browser.

12. A method of controlling a server computer, the method comprising:
rendering a web page to a web browser, the rendering including providing a script to the web browser that analyzes user interaction with the web browser;
receiving an asynchronous pre-request of data from the web browser resulting from the web browser predicting a selection of a user interactable component based on the script's analysis of the user's interaction with the web browser; and
pre-fetching the pre-requested data based on the asynchronous pre-request of data.

13. The method of claim 12, comprising:
registering a method; and
executing the method in response to the asynchronous pre-request of data from the web browser, the executing including the pre-fetching of the pre-requested data.

14. A computer readable storage medium storing computer-executable instructions for controlling a client computer to perform a method comprising:
predicting a user action based on the user's interaction with the client computer;
providing an asynchronous pre-request of data to a web server based on the predicted user action;
providing an actual request of data to the web server based on the user actually performing the predicted user action; and
receiving, in response to the actual request of data, data that was pre-fetched by the web server in response to the asynchronous pre-request of data.

15. The computer readable storage medium of claim 14, wherein the predicting comprises:
predicting a user selection of a user interactable component.

16. The computer readable storage medium of claim 15, wherein the predicting comprises:
tracking movement of a pointing device toward the user interactable component; and
predicting the user selection of a user interactable component based on the tracking of movement of the pointing device toward the user interactable component.

17. The computer readable storage medium of claim 16, wherein the tracking comprises:
tracking linear movement of a pointing device toward the user interactable component.

18. The computer readable storage medium of claim 16, wherein computer-executable instructions for controlling the tracking of movement of the pointing device toward the user interactable component are included in a script that also tracks pre-requests previously made based on an identification that associates a pre-fetch action based on the asynchronous pre-request, a fetch action based on the actual request, and the user interactable component.

19. The computer readable storage medium of claim 15, wherein providing the asynchronous pre-request of data to the web server is only provided for user interactable components that are marked as pre-fetchable.

20. The computer readable storage medium of claim 14, wherein the receiving comprises:
receiving, in response to the actual request of data, data from a cache on a server computer, that was pre-fetched and stored in the cache by the web server in response to the asynchronous pre-request of data.
